(19) United States
(12) Patent Application Publication
(10) Pub. No.: US 2025/0382231 A1
(43) Pub. Date: Dec. 18, 2025

(54) MICROWAVE SINTERING METHOD OF CLAY-CARBON MATERIALS IN ANTI-OXIDATIVE ATMOSPHERE

(71) Applicant: Thrasos 3D Corp, Dover, DE (US)

(72) Inventors: Vasilii KORSHIKOV, Monterrey (MX); Alena BORISOVNA KHARISSOVA, Monterrey (MX); Nikolai ZHIVOTENKO, Makashevka (RU)

(21) Appl. No.: 19/238,958

(22) Filed: Jun. 16, 2025

Related U.S. Application Data
(60) Provisional application No. 63/660,567, filed on Jun. 16, 2024.

(51) Int. Cl. C04B 33/04; C04B 33/13; C04B 33/30; C04B 33/32; C04B 35/528; C04B 35/626; C04B 35/645

(52) U.S. Cl. CPC C04B 33/04; C04B 33/13; C04B 33/30; C04B 33/32; C04B 35/528; C04B 35/62655; C04B 35/62675; C04B 35/645; C04B 2235/349; C04B 2235/422; C04B 2235/606; C04B 2235/6567; C04B 2235/6584; C04B 2235/667

(57) ABSTRACT

Methods for microwave sintering of clay-carbon materials in an anti-oxidative atmosphere and products produced thereby. In one embodiment, method of sintering a clay-carbon ceramic green body includes: providing a clay-carbon ceramic green body, the green body including clay and carbon, the carbon being present as at least one of charcoal, biochar, condensed carbon matter, and a combination thereof; and exposing the green body to microwave radiation within a protective atmosphere that prevents oxidation of the green body within a working chamber of a furnace, thereby heating the green body volumetrically to yield a sintered clay-carbon ceramic product, the protective atmosphere including at least one of the group consisting of: at least one inert gas, at least one reducing gas, and a mixture thereof.

### CROSS-REFERENCE TO RELATED APPLICATIONS

This Application is related to and claims the benefit of U.S. Provisional Application No. 63/660,567, filed Jun. 16, 2024, entitled MICROWAVE SINTERING METHOD OF CLAY-CARBON MATERIALS IN ANTI-OXIDATIVE ATMOSPHERE, the entirety of which is incorporated herein by reference.

### GOVERNMENT RIGHTS STATEMENT

N/A.

### TECHNICAL FIELD

The present technology is related to a novel microwave sintering process for producing low-carbon ceramic structures from clay-carbon formulations. The method enables rapid, low-emission microwave-induced densification of 3D-printed clay-carbon green bodies into finished ceramic components.

### BACKGROUND

Industrial sectors are under increasing pressure to find solutions to environmental problems related to the production of functional and structural ceramics and ceramic composite materials. The production process of low-carbon structural materials is attracting increasing attention due to its potential in the sustainable development of bio-technical systems. However, the modern ceramic production process requires a long sintering time and uses energy-intensive processes. In addition, currently known sintering processes of low-carbon composite ceramics are ineffective when the external conditions use an oxidizing atmosphere.

Traditional sintering methods for clay-carbon materials often involve prolonged heating processes in oxidative atmospheres, leading to oxidation and degradation of carbon components. For example, US Pub. No. 2024/0003626A1 proposes a method for regulating the oxygen concentration in the furnace atmosphere to protect green ceramics from oxidation. However, this method not only compromises the structural integrity, but also diminishes the desired properties of the material.

In recent years, microwave sintering has made significant strides in the production of ceramic materials, steadily gaining recognition and widespread adoption. While current literature primarily documents successful microwave sintering of functional ceramics, there remains a gap in its application, particularly in the realm of structural low-carbon ceramic structures from clay-carbon formulations. This is due to the fact that in the production of conventional technical and functional ceramics, sintering is carried out in a free oxidizing atmosphere, and the presence of carbon and carbon-containing compounds is undesirable.

Currently known methods of protecting the product from oxidation include glaze application techniques. However, such methods add production complexity and cost. Further, the resulting product may not be suitable for all applications, including in marine environments. Patent CN102173832 reflects that glaze application techniques are used to protect the product from oxidation. The utilization of microwave sintering structural ceramics in protective, anti-oxidative (inert or reducing) atmosphere offers novel approaches and methodologies, presenting new avenues for the preparation of high-performance, sustainable structural and functional components. By leveraging the unique advantages of microwave heating and anti-oxidation atmospheres, such as rapid heating, precise temperature control, selective energy absorption, anti-oxidation and reduction of substance, this method holds great potential for advancing structural ceramics manufacturing and unlocking new possibilities in sustainable construction materials, including biocompatible artificial reef structures suitable for marine installations.

### SUMMARY

Some embodiments advantageously provide methods for microwave sintering of clay-carbon materials in an anti-oxidative atmosphere and products produced thereby.

In one embodiment, method of sintering a clay-carbon ceramic green body includes: providing a clay-carbon ceramic green body, the green body including clay and carbon, the carbon being present as at least one of charcoal, biochar, condensed carbon matter, and a combination thereof; and exposing the green body to microwave radiation within a protective atmosphere that prevents oxidation of the green body within a working chamber of a furnace, thereby heating the green body volumetrically to yield a sintered clay-carbon ceramic product, the protective atmosphere including at least one of the group consisting of: at least one inert gas, at least one reducing gas, and a mixture thereof.

In one aspect of the embodiment, the green body is at least one of extruded, cast-molded, and 3D printed.

In one aspect of the embodiment, the protective atmosphere includes at least one of nitrogen, ammonia, carbon dioxide, helium, argon, hydrogen, and a mixture thereof.

In one aspect of the embodiment, the protective atmosphere has a pressure that is lower than atmospheric pressure or a pressure that is higher than atmospheric pressure.

In one aspect of the embodiment, the method further includes, before the step of exposing the green body to microwave radiation, applying a vacuum to the protective atmosphere to remove an oxygen-containing gas from the working chamber of the furnace.

In one aspect of the embodiment, the green body contains carbon material, the protective atmosphere preventing oxidation of the carbon material during sintering, such that the carbon material is present in the sintered clay-carbon ceramic product after sintering.

In one aspect of the embodiment, the carbon is present as condensed carbon matter, the condensed carbon matter including at least one of the group consisting of: silicon carbide, carbon materials obtained through the pyrolysis of organic matter, activated carbon, graphite, and a combination thereof.

In one aspect of the embodiment, the microwave radiation is delivered at a power of 1 to 30 kW and a frequency of 915 MHz or 2.45 GHz.

In one aspect of the embodiment, the exposing the green body to microwave radiation includes moderately heating the green body to a temperature of approximately 100° C. to 250° C. for a duration of 10 minutes to 240 minutes to remove moisture and bring the green body to a desired material humidity.

In one aspect of the embodiment, the exposing the green body to microwave radiation includes intensely heating the clay-carbon green body to a temperature of approximately 850° C. to 1400° C. for a duration of 10 minutes to 240 minutes.

In one aspect of the embodiment, the green body is exposed to microwave radiation more than once.

In one aspect of the embodiment, the method further includes using the sintered clay-carbon ceramic product as a construction material for at least one of civil, residential, commercial, and environmental construction.

In one aspect of the embodiment, the sintered clay-carbon ceramic product is used a construction material in a submerged structure in fresh, brine, or saltwater environments.

In one aspect of the embodiment, the sintered clay-carbon ceramic product is used as a biocompatible artificial reef structure in a marine environment.

In one aspect of the embodiment, a method of producing a sintered clay-carbon ceramic product includes: (a) forming a mixture of ingredients into a green body, the mixture of ingredients including water, an inorganic clay, and carbon-containing materials; and (b) sintering the green body with microwave radiation within a protective atmosphere that prevents oxidation of the green body within a working chamber of a furnace, thereby heating the green body volumetrically to yield the sintered clay-carbon ceramic product, the protective atmosphere including at least one inert gas, at least one reducing gas, and/or at least one mixture of inert and reducing gases.

In one aspect of the embodiment, the mixture of ingredients further includes at least one of a filler and a functional additive.

In one aspect of the embodiment, the carbon-containing materials include at least one of charcoal, biochar, graphite, and condensed carbon matter, the carbon-containing materials being present in the green body as carbon-containing dispersed particles; and at least some of the carbon-containing materials are present in the clay-carbon ceramic product after step (b) is performed.

In one aspect of the embodiment, the method further includes: after step (a) and before step (b), exposing the green body to microwave radiation to moderately heat the green body to a temperature of approximately 100° C. to approximately 250° C. to remove an amount of moisture from the green body, in step (b), the green body is exposed to microwave radiation to heat the green body to a temperature of approximately 850° C. to approximately 1400° C.

In one aspect of the embodiment, the protective atmosphere includes at least one of nitrogen, ammonia, carbon dioxide, helium, argon, hydrogen, and a mixture thereof.

In one embodiment, a sintered clay-carbon ceramic product is produced by: forming a mixture of ingredients into a green body, the mixture of ingredients including water, an inorganic clay, and carbon-containing materials; and then sintering the green body with microwave radiation within a protective atmosphere that prevents oxidation of the green body within a working chamber of a furnace, thereby heating the green body volumetrically to yield the sintered clay-carbon ceramic product, the protective atmosphere including at least one inert gas, at least one reducing gas, and/or at least one mixture of inert and reducing gases, the carbon-containing materials being present in the clay-carbon ceramic product after sintering.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows a microwave heating system, in accordance with the present disclosure; and

FIG. 2 shows an exemplary method for microwave sintering of clay-carbon materials in an anti-oxidative atmosphere, in accordance with the present disclosure.

### DETAILED DESCRIPTION

Before describing in detail exemplary embodiments, it is noted that the embodiments reside primarily in combinations of apparatus components and steps related to microwave sintering processes and low-carbon ceramic products produced therefrom. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The present invention relates to a novel microwave sintering process for producing low-carbon ceramic structures from clay-carbon formulations. The method enables rapid, low-emission microwave-induced densification of 3D printed clay-carbon green bodies into finished ceramic components.

The process utilizes microwave radiation to uniformly heat internal sections of a green body simultaneously. Microwave heating operates on the principle of direct interaction between microwave energy and the atomic or molecular structure within the material, resulting in efficient internal heating without the need for heat conduction. This enables faster, more energy-efficient sintering, and more precise control over heating and cooling processes to produce rapid thermal transitions for samples, compared to conventional external heating methods. The selective absorption of microwave energy by different components of the materials, based on their specific inductivity, enables targeted heating and functional optimization. This effect enhances atomic diffusion and reduces activation energy, leading to improved sintering outcomes. The clay-carbon formulations contain pyrolyzed carbonaceous materials (biochar, charcoal) and/or other condensed carbon substances that efficiently couple with microwaves, facilitating rapid volumetric heating.

Microwave sintering presents a promising alternative, offering rapid and uniform heating while minimizing oxidation. By utilizing an anti-oxidative (inert or reducing) atmosphere, the method of the present disclosure aims to preserve the carbon content and enhance the overall properties of the clay-carbon composite material.

Further, the methods of the present disclosure present new avenues for the preparation of high-performance, sustainable structural and functional components. By leveraging the unique advantages of microwave heating and anti-oxidation atmospheres, such as rapid heating, precise temperature control, selective energy absorption, anti-oxidation and reduction of substance, this method holds great potential for advancing structural ceramics manufacturing and unlocking new possibilities in sustainable and biocompatible artificial reef structure suitable for marine installations.

The method described herein is conducted in a controlled anti-oxidative atmosphere, preventing oxidation of carbon phases during sintering. This retains the carbonaceous additives' strengthening and toughening benefits in the final ceramic. The anti-oxidative atmosphere can contain nitrogen, ammonia, carbon dioxide, argon, helium, and/or other reducing or inert gases applied at a variety of pressures, including vacuum.

The microwave sintering in anti-oxidative conditions yields dense, strong ceramic structures with minimal shrinkage and emissions. The methods disclosed herein provide significant advantages over existing sintering processes, including faster densification, lower energy use, and preservation of carbon-based additives.

The presence of a protective anti-oxidative atmosphere allows reliable and repeatable retention of the carbon within carbon-containing ceramics, thereby preserving its advantageous properties, including strength and resilience. By preventing the carbon from oxidation, the atmosphere maintains the chemical integrity and characteristics of the carbon throughout the sintering process. Thus, after the sintering and post-processing are finished and the resulting product is obtained, the carbon is conserved in the material volume, resulting in a product with enhanced environmental sustainability performance. The methods and products disclosed herein offer a novel, long-term carbon dioxide removal (CDR) method that contributes to the global carbon capture, use and sequestration (CCUS) goals.

The advantages of the methods disclosed herein, stemming from the uniform temperature of the component, and in the resulting products include but are not limited to: increased strength and thermal shock resistance, reduced coefficient of thermal expansion, absence of internal/external cracks, and consistent porosity characteristics. Additionally, there is an increase in productivity (shorter cycle time), as previously these critical areas were significantly slowed down due to inefficiencies associated with surface heating during radiative heating. Furthermore, the microwave radiation provides faster and more energy-efficient sintering compared to conventional external heating methods, resulting in clay-carbon ceramic material with minimal carbon emissions compared to traditional kiln-firing methods.

The methods disclosed herein enable sustainable production of high-performance clay-carbon ceramic products representing a building material suitable for civil, residential, and/or commercial construction, and which are also suitable for underwater structures in fresh, sea or salt water, and mixtures thereof. In some embodiments, the methods disclosed herein are particularly suited for manufacturing artificial coral reef structures using recyclable, low-carbon ceramic formulations with specifically adjusted material and surface parameters, ensuring its increased biocompatibility compared to existing solutions in this field.

The methods disclosed herein relate to microwave processing and sintering of ceramics and ceramic composite materials manufactured by extrusion, casting, manual forming, and/or 3D printing methods. To this end, methods for preparing clay material and its transformation into a green body, drying processes, and sintering with microwave heating under a controlled, protective anti-oxidative atmosphere in the furnace chamber are described. Volumetric heating of ceramic materials using microwaves can be fundamentally used to overcome many difficulties associated with poor thermal conductivity characteristics of ceramic components. Although ceramics and ceramic composite materials and their components are noted in the present disclosure, it should be understood that the systems, methods, and/or products discussed herein are also applicable to any material having low thermal conductivity, which characteristic ordinarily would reduce the efficiency of heating delivered by convection in currently known methods.

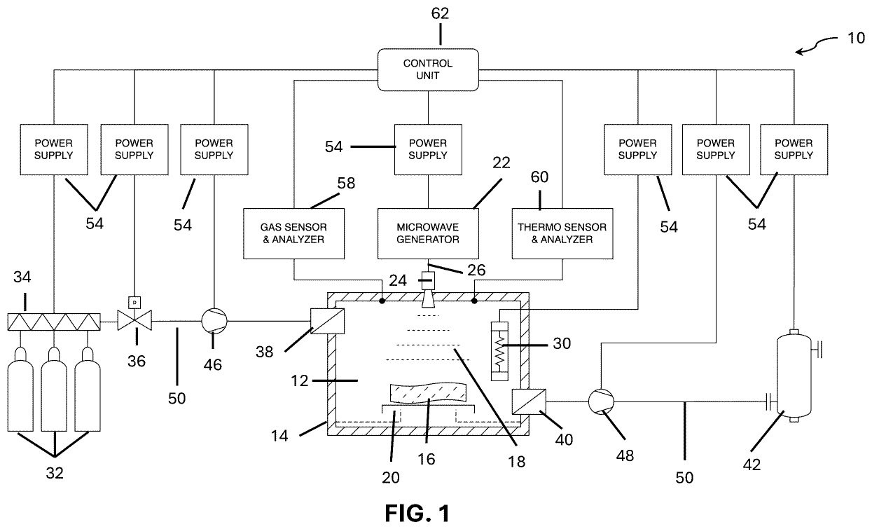

Referring now to FIG. 1, a microwave heating system is shown. In some embodiments, the microwave heating system is configured for use with ceramic materials. In some embodiments, the microwave heating system is configured for use according to any of the methods disclosed herein.

Continuing to refer to FIG. 1, in one embodiment the microwave heating system 10 generally includes a chamber, such as a microwave resonant cavity 12, with a heat-insulated enclosure 14 (including, but not limited to, a wall or encasement) inside of which the article 16 to be heated by microwave radiation 18 is placed. The microwave resonant cavity 12 and heat-insulated enclosure 14 may be collectively referred to herein as a furnace. In one embodiment, the furnace includes at least one sensor, such as a manometer or other pressure sensor. In one embodiment, the article is 16 composed of ceramic. In some embodiments, the article 16 is composed entirely of ceramic. In other embodiments, the article is composed at least partially of ceramic. However, as noted above, it will be understood that the article may be composed, entirely or in part, of any material requiring heating and demonstrating low thermal conductivity, or the factor determining the material heating rate will be mass transfer, with a low diffusion coefficient.

Continuing to refer to FIG. 1, in one embodiment the microwave heating system 10 further includes a turntable 20 or similar device or component that is configured to rotate the article 16 during the microwave heating process to provide uniform heating of the article 16.

Continuing to refer to FIG. 1, in one embodiment the microwave heating system 10 further includes a microwave generator 22 and a resonator 24, with the microwave generator 22 being directly or indirectly connected to the resonator 24 via one or more waveguides 26. The microwave generator 22 and resonator 24 are collectively referred to herein as the “microwave generation system.” In one embodiment, the microwave generator 22 is a magnetron. In one embodiment, the resonator 24 includes a rotating antenna. In one embodiment, the microwave generator 22 and/or the resonator 24 includes a controller configured to send and receive data from other system components and to continuously monitor, regulate, and adjust the generation and delivery of microwave power to the microwave resonant cavity 12.

Continuing to refer to FIG. 1, in one embodiment, the microwave heating system 10 further includes a heat source 30 in thermal communication with the microwave resonant cavity 12. In one embodiment, the heat source 30 is located entirely within the microwave resonant cavity 12. In one embodiment, the heat source 30 is located at least partially within the microwave resonant cavity 12. In some embodiments, the heat source 30 produces convective and/or radiant heat. In one embodiment, the heat source 30 includes an electrical resistance heater and/or a gas heater, having a direct or indirect burner configuration. In some embodiments, at least some of the heat used to heat the article 16 is provided by the microwave generation system. In some embodiments, the heat source 30 is used to pre-heat the article 16 before the article 16 is heated by the delivery of microwave energy by the microwave generation system. In some embodiments, the article 16 is heated by both the heat source 30 and the microwave generation system (e.g., simultaneously, sequentially, in an alternating fashion, according to a pre-determined delivery pattern, etc.). In some embodiments, all of the heat used to heat the article 16 is provided by the microwave generation system and no heat is provided by the heat source 30. In some embodiments, the microwave heating system 10 does not include a heat source 30 and all of the heat used to heat the article 16 is provided by the microwave generation system.

Continuing to refer to FIG. 1, in one embodiment the microwave heating system 10 further includes one or more reservoir 32 containing inert or reducing gases. In one embodiment, the microwave heating system 10 further includes at least one gas mixer 34 that is connected to the reservoir(s) 32. The reservoir(s) 32 may all contain the same single gas or the same mixture of gases, or each reservoir 32 may contain a different single gas or mixture of gases from the other reservoir(s) 32. In one embodiment, the gases from all or at least some of the reservoir(s) 32 are mixed within the gas mixer 34, so that a single mixed or homogenous gas is then passed from the gas mixer 34 to the microwave resonant cavity 12. However, in other embodiments, gas from a single reservoir 32 may be passed to the microwave resonant cavity 12 only, or independently from the other reservoir(s) 32. Further, in some embodiments, the flow of gas from each reservoir 32 may be regulated independently and without mixing with gases from other reservoir(s) 32. In another example, different volumes of gas from one two or more reservoirs 32 may be mixed within the gas mixer 34. In one embodiment, the flow of gas from the gas mixer 34 into the microwave resonant cavity 12 is regulated by a dosing valve 36. Further, in one embodiment, gas from the reservoir(s) 32 passes through a filter 38 before entering the microwave resonant cavity 12.

Continuing to refer to FIG. 1, in one embodiment the microwave heating system 10 further includes a filter 40 and an air separator and a purification/sequestration system 42 (referred to as a “sequestration system 42” for simplicity). In one embodiment, the sequestration system 42 is configured to remove potentially harmful components of the furnace exhaust and/or from the microwave resonant cavity 12, including, but not limited to, gaseous sulfur, carbon dioxide, and nitrogen oxides. In one non-limiting example, the sequestration system 42 includes one or more sorbents and/or filters suitable for removing target molecules or undesired components of furnace exhaust. In some embodiments, at least a portion of the furnace exhaust is released to the atmosphere (for example, after undesired components are filtered, extracted, sequestered, and/or sorbed). In one embodiment, a mixture of reaction products and gas are removed from the microwave resonant cavity 12 through the filter 40 and into the sequestration system 42 via one or more valves (not shown).

Continuing to refer to FIG. 1, in one embodiment the microwave heating system further includes a compressor 46, a vacuum pump 48, and/or other system components that are configured for, or operable to, change the atmospheric pressure in the microwave resonant cavity 12. In one non-limiting example, as shown in FIG. 1, a compressor 46 is located between and in-line with the dosing valve 36 and the filer 38, and a vacuum pump 48 is located between and in-line with the filter 40 and the sequestration system 42.

Continuing to refer to FIG. 1, in one embodiment the microwave heating system 10 further includes a plurality of conduits, lines, or other components (collectively referred to herein as “conduits 50”) for transferring gas and reaction products between, for example, the reservoir(s) 32, at least one gas mixer 34, valves (including the dosing valve 36), filters 38, 40, sequestration system 42, vacuum 46, compressor 48, and/or other system components. Additionally, in one embodiment the microwave heating system 10 further includes at least one power supply 54 for providing power to system components.

Continuing to refer to FIG. 1, in one embodiment the microwave heating system 10 further includes a gas control unit 58 that is configured to or operable to determine, analyze, send and receive data, store data, and/or control the delivery of gas from the reservoir(s) 32 to the gas mixer 34 and/or to the microwave resonant cavity 12. In one embodiment, the gas control unit 58 includes one or more sensors (for example, gas sensors, pressure sensors), processors, communications modules, and/or other components that enable the gas control unit 58 to send and receive data to and from a control unit, and to directly or indirectly control delivery of gas from the reservoir(s) 32 to the gas mixer 34 and/or to the microwave resonant cavity 12, as discussed below. Further, in some embodiments, the gas control unit 58 is in wired and/or wireless communication with one or more sensors located within the furnace. In one embodiment, the gas control unit 58 is in direct or indirect communication with the microwave resonant cavity 12. In one non-limiting example, the gas control unit 58 includes one or more sensors that detect the presence of any of a plurality of gases, and processing circuitry that is programmed or programmable to determine and/or analyze amounts of each gas, relative percentages of the gases within the microwave resonant cavity 12, to send data (including, but not limited to, analyses, determinations, and/or calculations) to the control unit, and/or to receive data from the control unit (including, but not limited to, start/stop commands, program mode commands, operational directives, and other commands and information).

Continuing to refer to FIG. 1, in one embodiment the microwave heating system 10 further includes a temperature control unit 60 that is configured to or operable to determine, analyze, send and receive data, store data, and/or control the generation of heat from the heat source 30 within the microwave resonant cavity 12. In one embodiment, the temperature control unit 60 includes one or more sensors, processors, communications modules, and/or other components that enable the temperature control unit 60 to send and receive data to and from a control unit, and to directly or indirectly control generation and delivery of heat from the heat source 30 to the microwave resonant cavity 12, as discussed below. In one embodiment, the temperature control unit 60 is in direct or indirect communication with the microwave resonant cavity 12. In one non-limiting example, the temperature control unit 60 includes one or more temperature sensors and processing circuitry that is programmed or programmable to determine and/or analyze temperature data, to send data (including, but not limited to, analyses, determinations, and/or calculations) to the control unit, and/or to receive data from the control unit (including, but not limited to, start/stop commands, program mode commands, operational directives, and other commands and information).

Continuing to refer to FIG. 1, in one embodiment the microwave heating system 10 further includes a master control unit 62 that is configured to or operable to determine, analyze, send and receive data, store data, and/or control the function of other system components. In one embodiment, the master control unit 60 includes one or more sensors, processors, communications modules, timers, and/or other components that enable the master control unit 62 to send and receive data to and from the gas control unit 58, the temperature control unit 60, the at least one power supply 54, the valves, the compressor 46, the vacuum pump 58, the gas mixer 34, the microwave generator 22, the resonator 24, sensor(s) throughout the system, and/or other system components to directly or indirectly control performance of the methods disclosed herein using the microwave heating system 10. Optionally, the master control unit 62 is in direct or indirect, wired or wireless, communication with one or more communications networks, user input devices, computers, tablets, storage devices (including, but not limited to, hard drives and cloud storage networks), displays, consoles, and/or other devices or components. In one non-limiting example, the master control unit 62 includes processing circuitry, communications modules, data storage modules, and/or other modules or components that are programmed or programmable to receive data (including, but not limited to, analyses, determinations, and/or calculations) from the gas control unit 58, the temperature control unit 60, and/or other system components, and/or to send data to the gas control unit 58, the temperature control unit 60, and/or other system components (including, but not limited to, start/stop commands, program mode commands, operational directives, valve open/close commands, and other commands and information). For example, in some configurations, data is transmitted between the gas control unit 58 and the master control unit 62, and between the temperature control unit 60 and the master control unit 62, in a feedback loop, wherein data transmitted from the gas control unit 58 and/or from the temperature control unit 60 are analyzed and interpreted by the master control unit 62, and may be used to update or change data, directives, commends, and/or other instructions from the master control unit 62 to alter or adjust system performance. In one non-limiting example, the master control unit 62 may raise the temperature within the microwave resonant cavity 12 by increasing output from the heat source 30 if data received from the temperature control unit 60 indicates that the temperature within the microwave resonant cavity 12 is too low. In another non-limiting example, the master control unit 62 is in wired and/or wireless communication with a controller of the microwave generator 22 and/or the resonator 24, between which and the master control unit 62 data is sent and received. The master control unit 62 may use data received from the microwave generator 22 and/or the resonator 24 to continuously monitor, regulate, and adjust the generation and delivery of microwave power to the microwave resonant chamber 12.

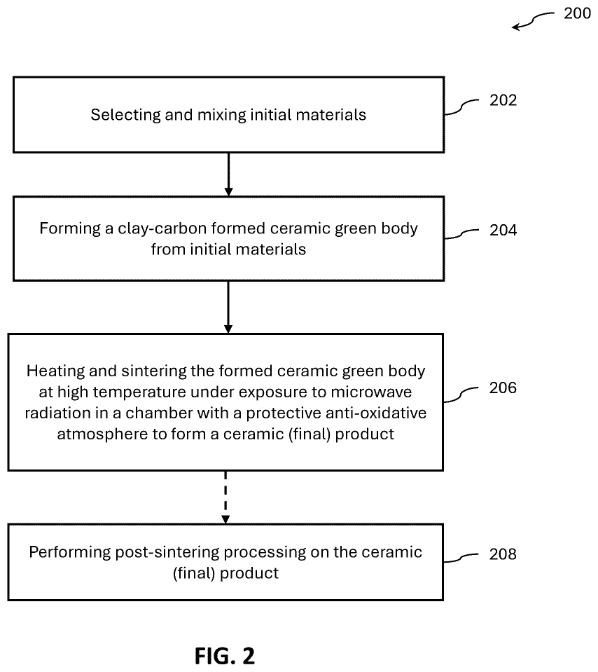

Referring now to FIG. 2, a method for microwave sintering of clay-carbon materials in an anti-oxidative atmosphere is shown. A method 200 for processing ceramic materials generally includes a first step 202 of selecting and mixing initial materials; a second step 204 of obtaining, producing, or forming a clay-carbon formed ceramic green body from the initial materials; and a third step 206 of drying and sintering the formed ceramic green body at high temperature under the influence of (under exposure to) microwave radiation in a chamber with a protective anti-oxidative atmosphere to form a ceramic (final) product. Optionally, the method 200 also includes one or more post-sintering steps 208, including, but not limited to, cooling and/or inspecting the final product and/or adding one or more decorative and/or functional coatings or treatments. The method may include additional fewer steps than are shown in FIG. 2.

In one embodiment of the first step 202 of the method 200, the initial materials that are mixed include water, the main inorganic clay substance and/or its components, carbon-containing dispersed particles in the form of charcoal, biochar, graphite, and condensed carbonaceous substances (including, but not limited to, carbon nanomaterials or nanoparticles, and/or combinations thereof). In one embodiment, the initial materials that are mixed further include optional fillers and/or functional and/or technological additives, such as deflocculants, organic additives, lubricants, thickeners, thixotropic additives, plasticizers, or other substances improving the rheological and structural behavior of the green body.

In one embodiment of the second step 204 of the method 200, the clay-carbon ceramic green body object is obtained by extrusion, mold casting, shaping by hand, three-dimensional printing, and/or other suitable methods.

In one embodiment of the third step 206 of the method 200, the formed ceramic green body undergoes volumetric heating and then sintering at high temperature to cause it to transition into a ceramic (final) product. In one embodiment, the formed ceramic green body is ultimately heated to a final temperature of approximately 850° C. to approximately 1400° C. (±20° C.) for a duration of 10 minutes to 240 minutes. At lower temperatures, as the formed ceramic green body is heated to the final temperature, the moisture content in the formed green ceramic body is reduced to about 4-10% without overdrying or affecting its shape and/or composition. In one non-limiting example, the moisture content in the formed ceramic green body may be reduced at a temperature of between approximately 100° C. to approximately 250° C. In some embodiments, the temperature of the formed ceramic green body may be held at between approximately 100° C. to approximately 250° C. for a duration of 10 to 240 minutes, which enables faster and more energy efficient water evaporation from the formed ceramic green body to achieved the desired material humidity before sintering at the final temperature. In other embodiments, the temperature of the formed ceramic green body is not held at a lower temperature before sintering. This heating and sintering is performed in the presence of microwave radiation in a chamber with a protective anti-oxidative atmosphere made of inert, reducing gases, and/or mixtures thereof. In one embodiment, the heating and sintering is performed with temperature and hold time control. In one embodiment, the heating and sintering is performed within the microwave resonant cavity 12 of the microwave heating system 10, in the presence of microwave radiation 18 generated by the microwave generator 22 and distributed by the resonator 24 (the microwave generation system). In one embodiment, the microwave generation system provides all of the heating, and reduction in moisture in the formed ceramic green body, in the third step 206. In some embodiments, at least some of the heating is provided by the heat source 30 and the remaining amount of heating is provide by the microwave generation system. In one non-limiting example, the formed ceramic green body may be pre-heated, and the moisture content therein reduced (such as to about 4-10%), by the heat source 30. In one embodiment, control of the time of the process and control of the temperature within the microwave resonant cavity 12 and heat produced by the heat source 30 is controlled by the master control unit 62 with feedback between the system components as discussed above (FIG. 1). In some embodiments, the third step 206 is performed more than once (for example, if required for a particular production method and/or end use of the final product).

It will be understood that the steps of the method 200 may be performed by one or more entities, at one or more locations, and at various time durations (for example, during the same day, within a few days, weeks, months, etc.).

With reference to FIGS. 1 and 2, the method is now discussed in greater detail. In one embodiment, the sintering process of a green body made of clay combined with a carbon substance is carried out in a protective, anti-oxidizing atmosphere, consisting of inert gases, reducing gases, a combination thereof, or vacuum. The primary function of the controlled anti-oxidative atmosphere is to prevent leaving of solid carbon-containing matter from the clay-carbon green body in a form of gaseous CO₂, formed due to oxidation of solid carbon materials during sintering. The secondary function of the controlled anti-oxidative atmosphere is to promote reduction of metal oxides, such as iron oxides, in presence of solid carbon-containing matter or reducing gases, which results in lowering their oxidation state and modifying the chemical composition and physical properties of the resulting ceramic material.

In this case, the protective, anti-oxidizing atmosphere refers to the atmospheric state where oxidation is inhibited or completely prevented due to the lowered content or complete absence of oxygen and other oxidizing gases or vapors. Instead, the anti-oxidizing atmosphere may include gases like hydrogen, carbon monoxide, methane, hydrogen sulfide, which act as active reductants and would readily react with any free oxygen to prevent oxidation or nitrogen, ammonia, carbon dioxide, helium, argon, or a mixture thereof, leading to expelling and replacing free oxygen in the working chamber.

In one embodiment, the desired or optimal properties of the protective anti-oxidative atmosphere, such as gas composition, gas partial pressures and the total pressure in the working chamber, are determined based on the specific components of the clay-carbon material, and necessary chemical reactions at operating temperatures, and/or can be determined experimentally depending on the requirements for the final product and the conditions of the sintering process. Accordingly, the reservoir(s) 32 of the microwave heating system 10 may be chosen and/or filled based on the pre-process determination of suitable gas(es).

In one non-limiting example of an atmosphere based on a mixture of carbon dioxide, carbon monoxide and nitrogen is an atmosphere containing a gas mixture of carbon dioxide (CO2) at approximately 50-80% of the total composition, carbon monoxide (CO) at approximately 20-40% of the total composition, nitrogen (N₂) at approximately 5-10% of the total composition. Further, in one embodiment pressure of the gas mixture within the microwave resonant cavity 12 is approximately 0.1 MPa/14.7 psi.

In another non-limiting example of an atmosphere based on carbon dioxide and nitrogen is an atmosphere containing a gas mixture of carbon dioxide (CO₂) at approximately 20-40% of the total composition, and nitrogen (N₂) at approximately 60-80% of the total composition. Further, in one embodiment pressure of the gas mixture within the microwave resonant cavity 12 is approximately 0.1 MPa/14.7 psi.

In another non-limiting example of an atmosphere based on carbon dioxide and nitrogen is an atmosphere containing argon (Ar) at 100% of the composition. Further, in one embodiment pressure of the gas within the resonant cavity 12 is approximately 0.1 MPa/14.7 psi.

In another non-limiting example of an atmosphere based on carbon dioxide and nitrogen is an atmosphere containing a gas mixture of carbon dioxide (CO₂) at approximately 20-40% of the total composition, nitrogen (N₂) at approximately 60-80% of the total composition. Further, in one embodiment pressure of the gas mixture within the microwave resonant cavity 12 is in the range of between 0.001 MPa/0.147 psi and 0.01 MPa/1.47 psi.

When determining the composition and partial pressures of the gas mixture, it must be taken into account that most reducing gases are flammable; therefore, concentrations should be determined with consideration of the general technological process and compliance with safety regulations.

The antioxidative action of the atmosphere containing reducing gases can be described as follows: when carbon-containing ceramics are exposed to high temperatures in a reducing atmosphere, active reducing gases such as hydrogen, methane or carbon monoxide react with oxygen present in the environment. This happens according to the following reaction:

$$Reductant ( {H}_{2} , {CH}_{4} , CO ) + Oxygen ( {O}_{2} ) \to Water ( {H}_{2} O ) + Carbon dioxide ( {CO}_{2} ) \qquad ( Equation 1 )$$

As a result of the reaction, water and carbon dioxide are formed, while oxygen, which can oxidize carbon, is removed from the environment as reaction products. Particularly, the carbon dioxide formed in this reaction can be later captured by adsorption on solid filters or membranes or sorbents installed or located in the ventilation system, with its further use or sequestration. For example, in one embodiment carbon dioxide and/or other target molecules are sequestered and/or removed from the system by the sequestration system 42.

Absorption of microwave radiation with frequencies of 915 MHz or 2.45 GHz with a reducing atmosphere containing gases, such as hydrogen and/or hydrocarbons, induces chemical reactions in materials. If the material contains oxidized components, such as metal oxides, a reducing atmosphere with gases like hydrogen can facilitate their reduction to the metallic state. This is particularly important in ceramic or cermet sintering processes.

The presence of a protective anti-oxidative atmosphere allows reliable and repeatable retention of the carbon within carbon-containing ceramics, thereby preserving its advantageous properties, including strength and resilience. By preventing the carbon from oxidation, the atmosphere maintains its chemical integrity and characteristics throughout the sintering process. Thus, after the sintering and post-processing are finished and the resulting product is obtained, the carbon is conserved in the material volume, resulting in a product with enhanced environmental sustainability performance. The methods described herein provide a novel means for long-term carbon dioxide removal (CDR) and contribute to the global carbon capture, use, and sequestration (CCUS) goals.

The presence of dispersed inclusions of carbon materials obtained by pyrolysis of organic matter (charcoal, biochar, etc.), activated carbon, graphite, silicon carbide, and/or combinations thereof leads to an increase in the physical and mechanical characteristics of the final product. This contribution can be described by the rule of mixtures for composite materials:

$$P = {P}_{clay} \cdot {φ}_{clay} + {\sum }_{i} {P}_{i} \cdot {φ}_{i} \qquad ( Equation 2 )$$

$${φ}_{clay} + {\sum }_{i} {φ}_{i} = 1 \qquad ( Equation 3 )$$

where P is property of composite, P_{clay} is property of clay, Pᵢ is property of inclusion, φ is volume fraction of components. In one embodiment, the volume fraction of inclusions is in the range of 10-70% of the total volume of the green body. However, it will be understood that additional functional inclusions may be added to ensure the required and/or desired properties of the final product.

During ceramic sintering/firing, high temperatures are required to enable mass transport processes that reduce surface area and achieve densification. However, the extremely low thermal conductivity of unfired ceramics (less than 0.7 W/(m·K)) results in significant temperature gradients, with the surface being much hotter than the center. This thermal mismatch leads to thermal stresses on the surface, proportional to the ceramic's modulus of elasticity and coefficient of thermal expansion (typically around 7.5·10-6 K-1). While initially causing compressive stresses that inhibit cracking, large gradients can ultimately lead to cracking.

Rapid sintering/firing is preferred for efficiency and finer microstructures, but necessitates high radiative surface loads. This further exacerbates temperature gradients due to low conductivity, shortening heating element life. Uneven sintering between the surface and center can then cause non-uniform material properties. Additionally, phase changes like α/β-quartz require careful temperature control to avoid volumetric issues.

Conventional radiant kilns struggle to provide uniform heating, so microwave processing is proposed as an alternative approach to address the temperature gradient challenges during ceramic sintering/firing. Main advantage of microwave processing is that by delivering energy directly inside the product, it can overcome the heat transfer issues within individual items and throughout the entire furnace. Advantages of the so-called bulk heating methods have long been recognized in other industries. However, ceramics, being a fundamentally non-conductive material, require the use of much higher microwave frequencies before effective heating can be achieved. Attempts have been made to heat ceramics at microwave frequencies ranging from 900 MHz to 30 GHz, and it has been found that many materials sinter quite effectively at these frequencies. Therefore, microwave heating may improve temperature uniformity within the material, activating diffusion and mass transport processes.

By transmitting microwave energy directly into the product, the problems of heat transfer between the product and the furnace chamber can be solved. This, in turn, should lead to a more uniform product and provide faster and more energy-efficient processing. Other benefits include a potential reduction in sintering temperature by as much as 100-300° C. with a corresponding improvement in energy efficiency.

Many ceramics, such as aluminum oxide, demonstrate relatively low dielectric losses, meaning they have relatively poor microwave absorption characteristics at low and medium temperatures and therefore do not heat up quickly in the fields of typical multimode resonators. However, as the critical temperature approaches, the losses sharply increase, and a phenomenon known as thermal runaway may occur. This effect is self-propagating, as hotter areas will preferentially absorb microwave energy and may eventually cause internal melting, while other cooler areas remain at ambient temperature. Therefore, it is necessary to monitor the electrical properties of the original ceramics such as dielectric permittivity, loss tangent, etc. It is precisely the dielectric losses that are part of the energy of the applied electric field that is dissipated in the dielectric as heat.

In general, industrial microwave radiation sources with intensities ranging from 1 to 30 kW and characteristic frequencies of 915 MHz and 2.45 GHz are proposed. This is due to absorption peaks of microwave radiation by certain components present in the green body. The physical principle of dielectric heating is based on losses due to dipole polarization of dielectrics.

When using electromagnetic microwave waves, heating is caused by molecular dipole rotation in the dielectric (typical dipole molecules being water molecules). For example, dielectric heating at a frequency of 2.45 GHz can occur due to energy absorption by water molecules. Liquid water has many molecular interactions that broaden the absorption peak. For this reason, the moisture content of the green body before sintering should remain in the range of 4% to 10%. Magnetron-based devices may be used as generators. As discussed above regarding FIG. 1, in one embodiment the microwave generator 22 of the microwave heating system 10 is magnetron. Forced oscillations of polar molecules under the action of an external electric field lead to intermolecular friction, resulting in heat being generated throughout the dielectric volume, accelerating diffusion and mass transfer processes, leading to sintering of the green body.

In non-ideal dielectric materials, which are partially or completely conductive to electric current, additional heating occurs due to conductivity. Therefore, the introduction of carbon-containing compounds and inclusions into the original clay enhances the efficiency of the process. The interaction of microwave radiation with carbon molecules involves both dipole and molecular effects. The dipole properties of carbon manifest in its ability to create electric dipoles. Carbon structures, often having flat, cylindrical, or spherical structures, in which carbon atoms form sp²-hybridized bonds, lead to the formation of flat aromatic systems. These electronic systems can react to the electric field of microwave radiation, creating electric dipoles and inducing their vibrational motions. This material heating process is the main mechanism of microwave interaction with carbon. In addition to the dipole mechanism, carbon structures have a high degree of energy condensation in their molecular structures, making them effective microwave absorbers. At the molecular level, microwave radiation induces vibrational and rotational motions of carbon molecules, leading to their thermal excitation and, consequently, an increase in the material's temperature. Microwave heating processes of carbon materials involve not only the vibrational and rotational motions of carbon molecules but also internal molecular reorganizations that may lead to structural changes in the material. This can include desorption of gases, release of water, decomposition of organic compounds, which also positively affects the energy absorption peaks at frequencies of 915 MHz and 2.45 GHz.

The cumulative heat release in the material per unit of time, due to the displacement of charged particles (polarization) and the flow of conduction currents, is expressed by the formula for the specific power of internal heat sources:

$$p = 2 π \cdot f \cdot {ε}_{0} \cdot {ε}^{′} \cdot tg δ \cdot {E}^{2} \qquad ( Equation 4 )$$

$${ε}_{0} = \frac{1}{{μ}_{o} {c}^{2}} , \qquad ( Equation 5 )$$

where p is specific energy power, W/m³; ƒ is frequency of the electromagnetic field, Hz; ε₀ is vacuum permittivity (˜8.854·10⁻¹² F/m); ε′ is relative permittivity of material; tgδ is the tangent of the dielectric loss angle; E is electric field strength, V/m; μ₀ is absolute magnetic permeability of vacuum (4π·10⁻⁷ H/m); and c is the speed of light in a vacuum, m/s.

Equations 4 and 5 imply that heating in a high-frequency current field occurs inertially and uniformly throughout the material volume (if it is homogeneous) and in each elementary particle regardless of its thermal conductivity coefficient and geometric dimensions. The duration of microwave heating depends solely on the power dissipated in the material and the electro-physical properties of the material characterized by its dielectric permittivity and loss tangent, and is independent of its shape and volume. This allows for the development of very high heating rates, i.e., to obtain exceptionally powerful, distributed heat sources within the body. However, the working intensity of the electric field cannot be increased beyond a certain limit, limited by the electrical strength of the processed material.

The specific power released in the material during microwave heating can also be calculated using Equations 4 and 5. However, the electromagnetic wave in the dielectric is lossily attenuated in the direction of propagation. The energy reaching the x-section decreases by the value of Δp, which must be taken into account when implementing microwave heating processes:

$$Δ p = p \cdot ( 1 - {e}^{- 2 ax} ) , \qquad ( Equation 6 )$$

where p is specific energy power applied to the surface of the material, W/m²; α is the attenuation coefficient of the electromagnetic wave, m⁻¹, is equal to:

$$α = {k}_{0} \cdot \sqrt{\frac{{ε}^{′}}{2}} \cdot tg δ \cdot {[ 1 + \sqrt{1 + {tg}^{2} δ} ]}^{- 1 / 2} \qquad ( Equation 7 )$$

$${k}_{0} = 2 m \cdot f \cdot \sqrt{{μ}_{0} {ε}_{0}} , \qquad ( Equation 8 )$$

or

$$α = \frac{1}{2} \cdot {k}_{0} \cdot \sqrt{{ε}^{′}} \cdot tg δ , at {tg}^{2} δ ≪ 1 ,$$

where k₀ is wavenumber for vacuum (free-space wavenumber), m⁻¹.

The depth h of the penetration of the electromagnetic field into the material is the distance at which the energy of the field decreases by a factor of e˜2.718:

$$h = \frac{1}{2 α} \approx \frac{λ \cdot {ε}^{′}}{2 π \cdot {ε}^{″}} = \frac{{λ}_{0}}{2 π \cdot \sqrt{{ε}^{′}} \cdot tg δ} \qquad ( Equation 9 )$$

$$λ = \frac{c}{f} \qquad ( Equation 10 )$$

$${ε}^{″} = {ε}^{′} \cdot tg δ , \qquad ( Equation 11 )$$

where λ₀ is wavelength in vacuum, m; λ is wavelength in material, m; ε″ is dielectric loss factor.

It follows that the penetration depth h decreases with increasing frequency. In the frequency range used for microwave heating of dielectrics (915 MHz, 2.45 GHz), the penetration depth is comparable to the linear dimensions of the material. For a uniform temperature increase in the entire volume of a homogeneous material, it is necessary to ensure that the depth of penetration of the electromagnetic wave into the material exceeds its thickness. Since the electromagnetic wave in the dielectric attenuates on a microwave, the temperature field in it is unevenly distributed. The wavelength in the dielectric is less than the wavelength in vacuum λ₀ by a factor of \sqrt{ε′}.

The bulk heating of clay is determined not only by the intensity of the radiation, but also by the possibilities of dielectric permeability of the original components. In general, clay contains up to 40% silicon dioxide, which has a high dielectric permeability. It is also known that in the temperature range from 25 to 1700° C., the change in the dielectric permeability of silicon dioxide does not exceed ±2% of the initial value. This positively affects the heating process.

With the cost of heat only for heating, the specific power p_{T} is expressed through the energy balance equation:

$${p}_{T} = \frac{{c}_{p} ρ}{η} \cdot \frac{Δ T}{Δ τ} \qquad ( Equation 12 )$$

where cₚ is specific heat capacity of the material at constant pressure, J/(kg·20 C.); p is material density, kg/m³; η is thermal efficiency of the process, taking into account the loss of heat to the environment; ΔT is the difference between the final and initial temperatures of the material, ° C.; Δτ is microwave heating time (duration), s.

When heat is spent only on evaporation of moisture (drying) or other volatile components, the specific power is expressed as follows:

$${p}_{W} = \frac{N ρ}{η} \cdot \frac{Δ W}{Δ τ} \qquad ( Equation 13 )$$

where N is latent heat of evaporation at a given temperature, J/kg; W is moisture content of the material (during drying, calculated by the mass of water divided by the mass of absolutely dry material), kg/kg; ΔW is the difference between the initial and final moisture content of the material, kg/kg.

When heat is spent jointly on heating and evaporation, the specific power released per unit volume of the material due to dielectric losses is equal to the sum of the specific p capacities calculated according to the energy balance equations p_{T} and p_{W}:

$$p = {p}_{T} + {p}_{W} . \qquad ( Equation 14 )$$

In one embodiment, the method disclosed herein is explained with reference to ceramic composites and ceramics based on clay-carbon green bodies, manufactured by extrusion, which are subjected to microwave radiation, allowing the clay-carbon green mass to be heated to a temperature ranging from approximately 850° C. to approximately 1400° C. for a duration of 10 minutes to 240 minutes in a protective anti-oxidative atmosphere. However, it will be understood that this method is applicable to any application where the dielectric characteristics of the material make it sensitive to rapid heating and deformation of the processed material.

In one embodiment, the method generally includes:
1. Clay Selection (for example, in the first step 202 of the method 200): The selection of the main inorganic clay material is based on the required properties of the final product. This may include clay with specific mineral composition and texture, ensuring desired mechanical, functional, and aesthetic characteristics.
2. Filler Material Selection (for example, in the first step 202 of the method 200): The selection of filler material is based on functional and operational requirements, as well as considering the environment in which the final product will be used. The use of charcoal, biochar, condensed carbon matter, or a combination thereof improves the mechanical properties of the finished part, carbon sequestration, and the sintering process. Components can be introduced in the form of dispersed particles, ground fibers, continuous yarns and fibers, rovings, mesh and fabric structures, nonwoven materials, volume reinforcement structures, volume weaving structures, etc. The mass or volume fraction of the filler may be in the range 10-70% by mass and should be individually determined for each specific product based on the specified requirements.
3. Selection of Functional and Technological Additives (for example, in the first step 202 of the method 200): Technological additives are selected based on the required properties of the final mixture, such as plasticizers to improve plasticity or stabilizers to prevent shrinkage or deformation. Additives may also include lubricants, thickeners, thixotropic additives, and various functional additives to improve desired physical and chemical properties. Such additives may include gases, liquids, solid particles to create porosities, ash/gel structures, percolation bridges, changes in magnetic, optical, and any other physicochemical properties of the material.
4. Preparation of Components (for example, in the first step 202 of the method 200): Dry clay and fillers are ground to a specific particle size using mills or crushing devices or introduced without grinding if required by the technological process.
5. Mixing and Moistening (for example, in the first step 202 of the method 200): Dry clay, structural, functional, and technological additives are added to the mixer together with water and/or other additional binding liquids (such as ethanol). All components are mixed for a specified time and at a specified speed to ensure uniform distribution of all ingredients. The volumetric and mass fractions of the binder, water, and/or aqueous solution component are calculated separately for each mixing process. Moistening is carried out until the optimal viscosity of the mixture is achieved, ensuring good shaping and extrusion.
6. Extrusion/3D Printing (for example, in the second step 204 of the method 200): The prepared viscous mixture is loaded into an extruder of a selected type, including, but not limited to, those designed for 3D printing. The mixture is extruded through the extruder nozzle at specified technological parameters to ensure consistency and repeatability in possible differences in the rheological behavior of the composite, along a specified trajectory, forming the required three-dimensional part.
7. Drying (for example, in the third step 206 of the method 200): The green body undergoes a process of natural or artificial drying to remove excess moisture. This drying can be carried out in drying cabinets, chambers, ovens, kilns, or outdoors. Drying may be performed on air or in a protective atmosphere. This stage is carried out gradually and carefully to avoid cracks and deformations in the clay product. Adjustments to the geometry of the product or the addition of material to restore geometry with the provision of interlayer strength are permitted. The moisture concentration in the green body is controlled according to the technical process, and the resulting moisture concentration is determined by the requirements for subsequent microwave sintering.
8. Finishing (for example, in the third step 206 of the method 200): After drying, the green body may undergo additional finishing operations such as grinding, with the purpose to achieve the desired object dimensions, to decorate the object or create functional elements such as connecting elements that cannot be created otherwise, as required by the design of the product or other specified requirements.
9. Microwave Sintering/Firing (for example, in the third step 206 of the method 200): After finishing, the green body undergoes sintering in special microwave ovens (for example, the microwave heating system 10 of FIG. 1) at a specific temperature, time and in the anti-oxidative atmosphere. Additional or preliminary firing procedures may also be carried out in muffle furnaces, according to the technical process if required. This process transforms clay into a ceramic composite material with desired mechanical, physical, chemical, and aesthetic properties.
10. Cooling and Inspection (for example, in an optional fourth step 208 of the method 200): After sintering, the products are cooled according to the specified temperature-time curve. The cooling may be conducted on air or in the anti-oxidative atmosphere. Subsequently, the finished products undergo an inspection process for defects.
11. Coating Application (for example, in an optional fourth step 208 of the method 200): If the product has passed quality control after sintering, it can proceed to applying decorative or functional coatings, if indicated in the process map.

Thus, the proposed technological process allows for the production of high-quality ceramic products using the main inorganic clay material, ensuring production efficiency and cost-effectiveness.

In some embodiments, the ceramic product (referred to as a final product or clay-carbon ceramic product) may be used for one or more applications. Non-limiting examples of such use include use as a construction material for civil, residential, and/or commercial construction. For example, construction materials could include, but are not limited to, building blocks for load-bearing and non-load-bearing walls, wall and floor tiles, and other architectural design elements. Other non-limiting examples include use as a construction material for environmental construction, such as in submerged structures in fresh, brine, and/or saltwater environments. For example, the ceramic product may be formed and/or decorated to resemble coral, rocks, or other naturally occurring underwater organisms or structures. For example, in one embodiment, the ceramic product is formed and/or decorated to resemble or function as an artificial reef structure suitable for marine installations. In this case, the initial materials used to form the ceramic product are selected to include materials that ensure the ceramic product is biocompatible with the surrounding environment.

### Embodiments

In one embodiment, a method of sintering a clay-carbon ceramic green body, comprising: providing a clay-carbon ceramic green body, wherein said green body is obtained through extrusion, cast-molding, or three-dimensional printing; said green body comprising clay and carbon, wherein said carbon is present as charcoal, biochar, condensed carbon matter, or a combination thereof; exposing said green body to microwave radiation, thereby heating said green body volumetrically; wherein said exposing occurs in a protective atmosphere that prevents oxidation of the material, comprising inert gases, reducing gases, or a mixture thereof; thereby yielding a sintered clay-carbon ceramic body.

In one aspect of the embodiment, said anti-oxidizing atmosphere comprises nitrogen, ammonia, carbon dioxide, helium, argon, hydrogen, or a mixture thereof.

In one aspect of the embodiment, said anti-oxidizing atmosphere has pressure lower or higher than atmospheric pressure.

In one aspect of the embodiment, said anti-oxidizing atmosphere effect is achieved by using vacuum to remove oxygen-containing gas mixture, such as air, from the working chamber of the furnace.

In one aspect of the embodiment, said anti-oxidative atmosphere prevents oxidation of said carbon during sintering, thereby retaining strengthening and toughening benefits of said carbon in said ceramic product.

In one aspect of the embodiment, said condensed carbon matter comprises silicon carbide, carbon materials obtained through the pyrolysis of organic matter (charcoal, biochar), activated carbon, graphite, or a combination thereof.

In one aspect of the embodiment, said microwave exposure is conducted at a power of 1 to 30 kW and a frequency of 915 MHz or 2.45 GHz.

In one aspect of the embodiment, said exposure to microwave radiation allows moderate heating the clay-carbon green body up to a temperature of 100° C. to 250° C. for a duration of 10 to 240 minutes; said exposure to microwave radiation enables faster and more energy-efficient water evaporation from the clay-carbon green body to achieve desired material humidity before sintering, compared to traditional convection heat drying methods.

In one aspect of the embodiment, said exposure to microwave radiation allows intense heating the clay-carbon green body up to a temperature of 850° C. to 1400° C. for a duration of 10 minutes to 240 minutes; said exposure to microwave radiation enables faster and more energy-efficient sintering compared to conventional external heating methods, thereby yielding the clay-carbon ceramic body with minimal carbon emission compared to traditional kiln firing methods.

In one aspect of the embodiment, in a clay-carbon ceramic body produced according to the methods of the previously described embodiments, said ceramic body is exposed to microwave radiation more than once, if required for the specific production method or product use case.

In one aspect of the embodiment, said clay-carbon ceramic product is a construction material suitable for civil, residential and commercial construction.

In one aspect of the embodiment, said clay-carbon ceramic product is a construction material suitable for submerged structures in fresh, brine or salt water environments.

In one aspect of the embodiment, said clay-carbon ceramic product is a biocompatible artificial reef structure suitable for marine installations.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

It should be understood that various aspects disclosed herein may be combined in different combinations than the combinations specifically presented int eh description and the accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, temperature regulation, gas mixture and regulation, and other functionalities of the system.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer.

Instructions may be executed by one or more processors, such as one or more digital signal processors (DSPs), general purpose microprocessors, application-specific integrated circuits (ASICs), field programmable logic arrays (FPGAs), or other equivalent or integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A method of sintering a clay-carbon ceramic green body, the method comprising:
providing a clay-carbon ceramic green body, the green body including clay and carbon, the carbon being present as at least one of charcoal, biochar, condensed carbon matter, and a combination thereof; and
exposing the green body to microwave radiation within a protective atmosphere that prevents oxidation of the green body within a working chamber of a furnace, thereby heating the green body volumetrically to yield a sintered clay-carbon ceramic product, the protective atmosphere including at least one of the group consisting of: at least one inert gas, at least one reducing gas, and a mixture thereof.

2. The method of claim 1, wherein the green body is at least one of extruded, cast-molded, and 3D printed.

3. The method of claim 1, wherein the protective atmosphere includes at least one of nitrogen, ammonia, carbon dioxide, helium, argon, hydrogen, and a mixture thereof.

4. The method of claim 1, wherein the protective atmosphere has a pressure that is lower than atmospheric pressure or a pressure that is higher than atmospheric pressure.

5. The method of claim 1, further comprising, before the step of exposing the green body to microwave radiation, applying a vacuum to the protective atmosphere to remove an oxygen-containing gas from the working chamber of the furnace.

6. The method of claim 1, wherein the green body contains carbon material, the protective atmosphere preventing oxidation of the carbon material during sintering, such that the carbon material is present in the sintered clay-carbon ceramic product after sintering.

7. The method of claim 1, wherein the carbon is present as condensed carbon matter, the condensed carbon matter including at least one of the group consisting of: silicon carbide, carbon materials obtained through the pyrolysis of organic matter, activated carbon, graphite, and a combination thereof.

8. The method of claim 1, wherein the microwave radiation is delivered at a power of 1 to 30 kW and a frequency of 915 MHz or 2.45 GHz.

9. The method of claim 1, wherein the exposing the green body to microwave radiation includes moderately heating the green body to a temperature of approximately 100° C. to 250° C. for a duration of 10 minutes to 240 minutes to remove moisture and bring the green body to a desired material humidity.

10. The method of claim 1, wherein the exposing the green body to microwave radiation includes intensely heating the clay-carbon green body to a temperature of approximately 850° C. to 1400° C. for a duration of 10 minutes to 240 minutes.

11. The method of claim 1, wherein the green body is exposed to microwave radiation more than once.

12. The method of claim 1, further comprising using the sintered clay-carbon ceramic product as a construction material for at least one of civil, residential, commercial, and environmental construction.

13. The method of claim 12, wherein the sintered clay-carbon ceramic product is used a construction material in a submerged structure in fresh, brine, or saltwater environments.

14. The method of claim 13, wherein the sintered clay-carbon ceramic product is used as a biocompatible artificial reef structure in a marine environment.

15. A method of producing a sintered clay-carbon ceramic product, the method comprising:
(a) forming a mixture of ingredients into a green body, the mixture of ingredients including water, an inorganic clay, and carbon-containing materials; and
(b) sintering the green body with microwave radiation within a protective atmosphere that prevents oxidation of the green body within a working chamber of a furnace, thereby heating the green body volumetrically to yield the sintered clay-carbon ceramic product, the protective atmosphere including at least one inert gas, at least one reducing gas, and/or at least one mixture of inert and reducing gases.

16. The method of claim 15, wherein the mixture of ingredients further includes at least one of a filler and a functional additive.

17. The method of claim 15, wherein:
the carbon-containing materials include at least one of charcoal, biochar, graphite, and condensed carbon matter, the carbon-containing materials being present in the green body as carbon-containing dispersed particles; and
at least some of the carbon-containing materials are present in the clay-carbon ceramic product after step (b) is performed.

18. The method of claim 17, further comprising:
after step (a) and before step (b), exposing the green body to microwave radiation to moderately heat the green body to a temperature of approximately 100° C. to approximately 250° C. to remove an amount of moisture from the green body,
in step (b), the green body is exposed to microwave radiation to heat the green body to a temperature of approximately 850° C. to approximately 1400° C.

19. The method of claim 15, wherein the protective atmosphere includes at least one of nitrogen, ammonia, carbon dioxide, helium, argon, hydrogen, and a mixture thereof.

20. A sintered clay-carbon ceramic product, wherein the clay-carbon ceramic product is produced by:
forming a mixture of ingredients into a green body, the mixture of ingredients including water, an inorganic clay, and carbon-containing materials; and
then sintering the green body with microwave radiation within a protective atmosphere that prevents oxidation of the green body within a working chamber of a furnace, thereby heating the green body volumetrically to yield the sintered clay-carbon ceramic product, the protective atmosphere including at least one inert gas, at least one reducing gas, and/or at least one mixture of inert and reducing gases, the carbon-containing materials being present in the clay-carbon ceramic product after sintering.
